(19) United States
(12) Patent Application Publication
(10) Pub. No.: US 2005/0071682 A1
(43) Pub. Date: Mar. 31, 2005

(54) Layer 2 switch device with verification management table

(75) Inventor: Hideki Kurokawa, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 10/952,808

(22) Filed: Sep. 30, 2004

(30) Foreign Application Priority Data
Sep. 30, 2003 (JP) 2003-339936

(51) Int. Cl. H04L 9/32

(52) U.S. Cl. 713/201; 709/223; 370/420

(57) ABSTRACT

A layer 2 switch device, an authentication server, and a terminal device are connected to each other by a network, and a plurality of radio base stations are connected to the layer 2 switch device. A radio mobile terminal is authenticated by the authentication server. When a radio base station receives authentication result information from the authentication server, the radio base station sends the association information and authentication result information of the radio mobile terminal to the layer 2 switch device, which registers the received information in an authentication management table thereof. Subsequently, the layer 2 switch device manages the association information, authentication result information, and crypt key information of the radio mobile terminal in its own authentication management table. When the layer 2 switch device receives a re-authentication request from the radio mobile terminal, the layer 2 switch device refers to the information stored in the authentication management table. If the radio mobile terminal has already been authenticated, then the layer 2 switch device sends an access permission to the radio base station.

### BACKGROUND OF THE INVENTION

1. Field of the Invention

The present invention relates to a network system having a plurality of radio base stations, and more particularly to a layer 2 switch device and a radio base station in a network system which allows roaming service between a plurality of radio base stations to continue communications even when a radio mobile terminal, which performs radio communications through radio base stations, moves from a range (service area) for radio communications with a radio base station into a service area for radio communications with another radio base station.

2. Description of the Related Art

Heretofore, in radio LAN (Local Area Network) systems which utilize radio waves as the transmission medium, a radio base station perform an appropriate authentication process in response to an access request from a radio mobile terminal. The radio base station is associated with an authentication server which manages authentication processes and authentication information of radio mobile terminals. In response to an authentication request from a radio mobile terminal, the radio base station sends an inquiry to the authentication server to determine whether the radio mobile terminal is an accessible terminal or not. If the radio mobile terminal is judged as an accessible terminal based on an answer from the authentication server, there the radio base station stores the authentication result information from the authentication server and association information of the radio mobile terminal into its internal memory, and permits access from the radio mobile terminal to the network. The radio base station and the radio mobile station communicate with each other using a predetermined crypt key in order to prevent eavesdropping in the radio zone therebetween.

The radio LAN system usually has layer 2 switch devices for performing layer 2 switching, such as switching hubs and routers, with a plurality of radio base stations connected to the layer 2 switch devices.

Service areas are constructed and used such that radio mobile terminals are capable of gaining access to the network even when they move from the communication range of one radio base station into the communication range of another radio base station. Since radio waves are employed as the transmission medium, radio mobile terminals can frequently switch between radio base stations to access the network because of their mobility.

In the conventional radio LAN system, since each radio base station stores the authentication result information and association information of a radio mobile terminal in its internal memory and performs access management based on the stored information, when the radio mobile terminal moves and switches to another radio base station, the radio base station that the radio mobile terminal has switched to needs to carry out an authentication process with the authentication server.

The radio LAN system is widely known as ISO (International Organization for Standardization) 802.11, and recently is available as a high-speed 802.11b/g/a systems. Standardization efforts such as an 802.1x system are underway with IEEE (Institute of Electrical and Electronics Engineers) for authentication processes and encryption techniques. In recent years, techniques for dynamically changing crypt keys have widely been used for increasing the security of radio LAN systems.

Japanese laid-open patent publication No. 2003-5641 filed earlier by the present applicant discloses a system wherein a radio mobile terminal searches an AP (Access Point) information management table thereof to determine whether the MAC (Media Access Control) address of a radio base station is present in the AP information management table or not. With respect to a radio mobile terminal that has completed a first authentication process, second and subsequent authentication processes for the same radio base station after the first authentication is canceled are simplified.

In the conventional radio LAN system, as described above, when a radio mobile terminal moves and switches to another radio base station, the radio base station that the radio mobile terminal has switched to needs to carry out an authentication process with the authentication server.

As a result, it takes some time for the radio mobile terminal to switch between different radio base stations. Such a switching process will be described in greater detail with respect to a radio LAN system which employs the authentication procedure according to IEEE 802.1x. When a radio mobile terminal is to start gaining new access to a radio base station, the radio base station begins an access authentication process for the radio mobile terminal in accordance with a predetermined authentication procedure. If the authentication of the radio mobile terminal is performed by an external authentication server such as a RADIUS (Remote Authentication Dial In User Service) or an MAC ACL (Access Control List) server, then the radio base station sends an inquiry to the external authentication server about an authentication request from the radio mobile terminal, and permits or does not permit access from the radio mobile terminal. After the radio mobile terminal sends the authentication request for access, and the radio base station sends the inquiry to the external authentication server and receives the response therefrom until the radio base station permits access from the ratio mobile terminal, a period of time ranging from about 1 to 1.5 seconds has to be consumed due to an exchange of various items of information such as the user name and password of the ratio mobile terminal and an encrypted digital authentication certificate, and a time lag caused by a delay in the network and an authentication server searching process.

Large-scale systems such as a public radio LAN service systems often have an authentication server located remotely from the network. In this case, it takes a longer period of time for a radio mobile terminal to gain access to the network.

When a radio mobile terminal moves from the service area of a radio base station, to which the authenticated radio mobile terminal has been allowed to gain access, into the service area of another radio base station, the radio mobile terminal is required to suspend its communications for a period of time in which the radio base station exchanges necessary information with the authentication server for authenticating the radio mobile terminal again. In applications for sending and receiving multimedia data including audio and video data in real-time, such a re-authentication process is time-consuming, tending to give rise to problems such as audio data interruptions and video playback failures.

The system revealed in the above patent publication is effective to speed up the second and subsequent authentication processes requested from the radio mobile terminal to the same radio base station. However, the system gives no consideration to switching between radio base stations upon movement of the radio mobile terminal.

### SUMMARY OF THE INVENTION

It is therefore an object of the present invention to provide a layer 2 switch device and a radio base station which dispense with a re-authentication process and shorten a period of time required for access switching even when a radio mobile terminal moves from the service area of a radio base station into the service area of another radio base station and hence needs to switch between the radio base stations to communicate with.

According to a first aspect of the present invention, a layer 2 switch device has an authentication management table, means for storing authentication result information sent from an authentication server to a radio base station when a radio mobile terminal belonging to the radio base station is authenticated by the authentication server, in association with information specifying the radio mobile terminal into the authentication management table, and means for authenticating the radio mobile terminal based on the authentication result information stored in the authentication management table when an authentication request is sent from the radio mobile terminal.

According to a second aspect of the present invention, a radio base station has control means, responsive to an authentication request sent from a radio mobile terminal, for sending an inquiry to a layer 2 switch device and performing an authentication process based on a response to the inquiry.

For a re-authentication process to be performed when a radio mobile terminal switches to a radio base station, the layer 2 switch device manages, in the authentication management table stored in its memory, the association information, authentication result information, and crypt key information, which have heretofore been managed by the radio base station. In response to a re-authentication request from the radio base station to which the radio mobile terminal switches, the layer 2 switch device refers to the authentication management table. If the radio mobile terminal has already been authenticated, the layer 2 switch device sends an authentication response representative of an access permission. If the radio mobile terminal has not been authenticated, the layer 2 switch device sends an authentication response representative of an access denial. In response to an authentication request sent from the radio mobile terminal for re-access, the radio base station sends an inquiry to the layer 2 switch device to ask for the authentication result information, and manages access depending on the result sent from the layer 2 switch device.

When the radio mobile terminal moves and switches to another radio base station, therefore, a re-authentication process by the authentication server is dispensed with, thus shortening a period of time required for access switching.

According to the above authentication management, even if the radio mobile terminal performs data communications handling multimedia data including audio and moving image data, the radio mobile terminal can switch between radio base stations while continuing the data communications without interrupting the audio and moving image data.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a schematic block diagram showing an arrangement of a network system according to an embodiment of the present invention;

FIG. 2 is a block diagram of a radio base station in the network system shown in FIG. 1;

FIG. 3 is a block diagram of a layer 2 switch device in the network system shown in FIG. 1;

FIG. 4 is a diagram showing, by way of example, of data of an authentication management table in the layer 2 switch device shown in FIG. 3; and

FIG. 5 is a sequence chart showing an exchange of data from a first authentication process to a re-authentication process in the network system shown in FIG. 1.

### DESCRIPTION OF THE PREFERED EMBODIMENT

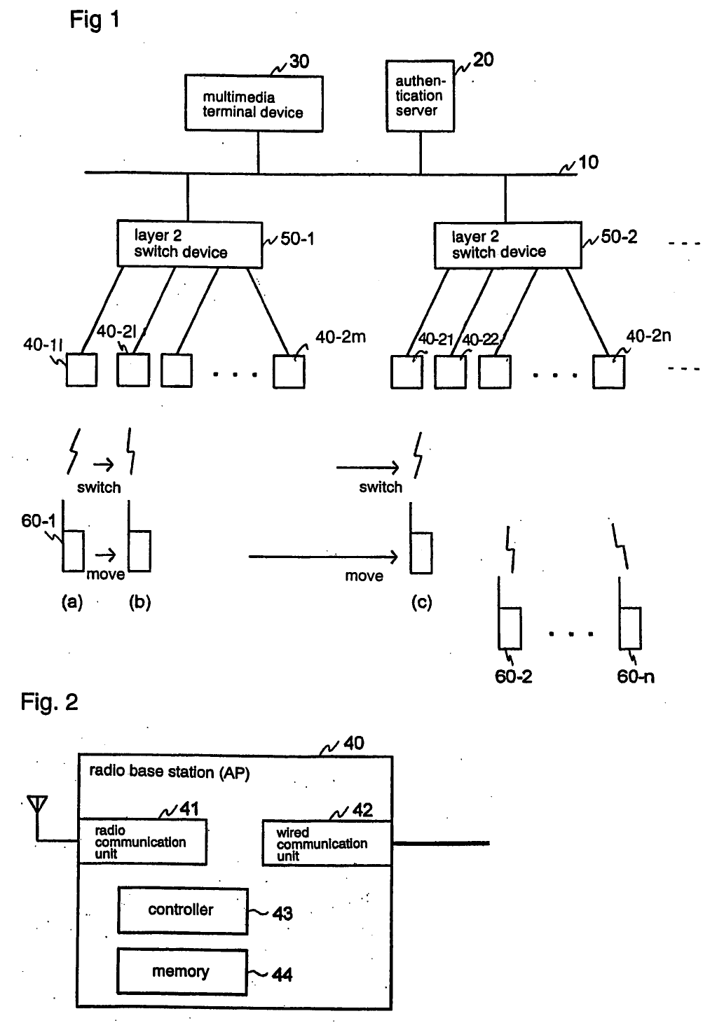

Refering now to FIG. 1, there is illustrated a network system according to an embodiment of the present invention having authentication server 20, multimedia terminal device 30, a plurality of layer 2 switch devices 50-1, 50-2, . . . (collectively referred to as layer 2 switch device 50 if a particular one is not specified), wired LAN 10 interconnecting them with communication cables, a plurality of radio base stations 40-11, 40-21, . . . (collectively referred to as radio base station 40 if a particular one is not specified) connected to layer 2 switch device 50-1, and a plurality of radio base stations 40-12, 40-22, (collectively referred to as radio base station 40 if a particular one is not specified) connected to layer 2 switch device 50-2. The network system also has a plurality of radio mobile terminals 60-1, 60-2, . . . (collectively referred to as radio mobile terminal 60 if a particular one is not specified) which can gain access to LAN 10. Each of base radio stations 40 is connected to LAN 10 through one of layer 2 switch devices 50, and provides a service area as a range in which radio mobile terminal 60 can gain access to LAN 10.

Radio mobile terminal 60 performs radio communications with one radio base station 40 within a range (service area) for radio communications with radio base station 40, and accesses LAN 10 through layer 2 switch device 50 to which radio base station 40 is connected. When radio mobile terminal 60 is authenticated by authentication server 20 connected to LAN 10, radio mobile terminal 60 communicates with multimedia terminal device 30 connected to LAN 10 in real-time.

Authentication server 20 stores authentication information for performing authentication to establish communications, and has an authentication function for permitting or rejecting communications based on the stored authentication information. Authentication server 20 also sends authentication result information which is required to re-authenticate radio mobile terminal 60 when communications between radio base station 40 and radio mobile terminal 60 that has once been authenticated are cut off, to radio base station 40 with which radio mobile terminal 60 has communicated.

Multimedia terminal device 30 is a device such as multimedia PC (Personal Computer) or the like which as a function to send and receive data through LAN 10 in a real-time.

As shown in FIG. 2, radio base station 40 has radio communication unit 41, wired communication unit 42, controller 43 for controlling the base station in its entirety according to a program (not shown), and memory 44. When radio communication unit 41 receives an authentication request from ratio mobile terminal 60, controller 43 sends an inquiry to layer 2 switch device 50 that is connected to wired communication unit 42, and performs an authentication process based on a response to the inquiry. Specifically, if layer 2 switch device 50 connected to radio base station 40 stores authentication result information with respect to ratio mobile terminal 60, then controller 43 re-authenticates ratio mobile terminal 60 based on the authentication result information from layer 2 switch device 50. If layer 2 switch device 50 connected to radio base station 40 does not store authentication result information with respect to ratio mobile terminal 60, then controller 43 controls radio base station 40 to perform an authentication process between authentication server 20 and ratio mobile terminal 60 via layer 2 switch device 50. Radio base station 40 stores the authentication result information sent as the response to the inquiry in the memory 44. Therefore, even if radio communications between radio base station 40 and radio mobile terminal 60 which belongs thereto are temporarily cut off, radio base station 40 can quickly resume and continue radio communications between itself and radio mobile terminal 60.

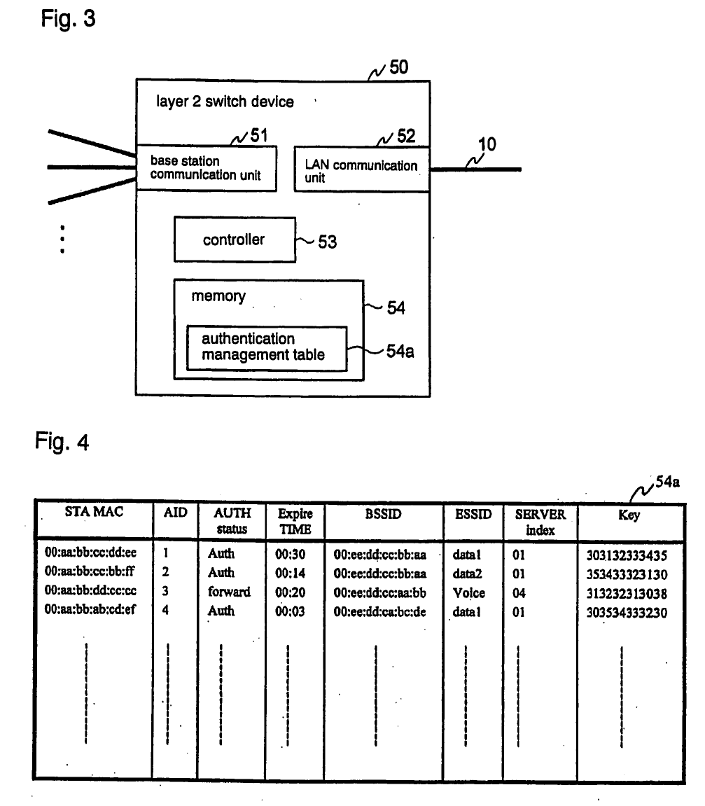

As shown in FIG. 3, layer 2 switch device 50 has base station communication unit 51, LAN communication unit 52, controller 53 for controlling the layer 2 switch device in its entirety according to a program (not shown), and memory 54. Memory 54 stores authentication management table (database) 54a therein.

As shown in FIG. 4, authentication management table 54a contains data in the columns of association ID (AID), authentication status (AUTH status), authentication result information expiration time (Expire TIME), basic service identifier (BSSID) of radio base station 40 with which radio mobile terminal 60 is associated, extended service identifier (ESSID) of a radio network used by radio mobile terminal 60 and radio base station 40, authentication server index (SERVER index), and crypt key information (Key) that are associated with MAC addresses (STA MAC: information specifying radio mobile terminals) of radio mobile terminals.

Association ID (AID) represents a unit number which is given from authentication server 20 when radio mobile terminal 60 is associated with radio base station 40.

Authentication status (AUTH status) represents an authentication result from authentication server 20. Of the data in the column of authentication status (AUTH status), “Auth” represents an authentication completion, and “Forward” represents a response to an inquiry from another layer 2 switch device 50 that is connected to LAN 10, indicating that radio mobile terminal 60 is moving.

Authentication server index (SERVER index) is an index for specifying which authentication server 20 has authenticated radio mobile terminal 60 if a plurality of authentication servers 20 are connected to LAN 10. Authentication server index (SERVER index) is used as when radio mobile terminal 60 is to be re-authenticated with Expire timeout.

Crypt key information (Key) is used for encryption in radio communications between radio mobile terminal 60 and radio base station 40, and comprises secret key information used by radio mobile terminal 60.

The authentication result information referred to above comprises an authentication status and an association ID. Association information at the time radio mobile terminal 60 is authenticated by authentication server 20 comprises BSSID and authentication server index that are associated with the MAC address and the association ID of the radio mobile terminal. Specifically, the MAC address and the association ID of the radio mobile terminal serve as information for identifying the radio mobile terminal, the BSSID indicates which radio base station 40 radio mobile terminal 60 belongs to, and the authentication server index indicates which authentication server 20 has authenticated radio mobile terminal 60.

The network system according to the present embodiment is applicable as a radio LAN system for performing data communications based on the Internet protocol (IP), particularly, real-time communications handling audio and moving image data. As layer 2 switch device 50 has a re-authentication function, real-time data communications, such as multimedia data communications, between radio mobile terminal 60 and multimedia terminal device 30, can be carried out without failures such as interruptions.

Operation of the network system according to the present embodiment will be described below.

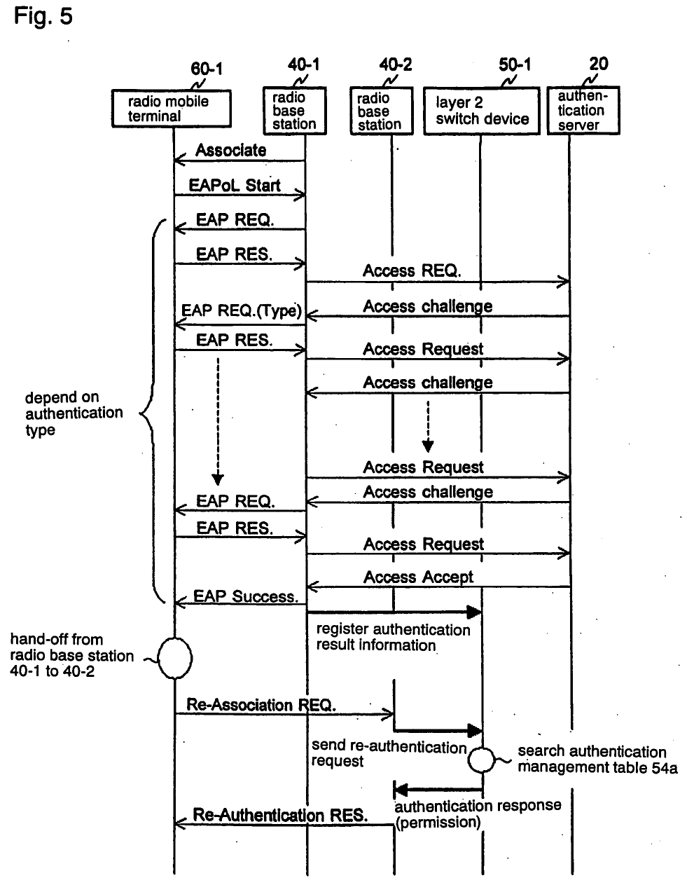

An authentication process for radio mobile terminal 60 to take part in network communications in the network system according to the present embodiment, e.g., for radio mobile terminal 60-1 to make real-time communications with multimedia terminal device 30 in the network from the service area of radio base station 40-1, will be described below with reference to FIG. 5.

First, radio mobile terminal 60-1 sends an access request to radio base station 40-1. Radio base station 40-1 sends an inquiry to predetermined authentication server 20 to ask whether radio mobile terminal 60-1 can take part in the network or not. Based on the authentication result, radio base station 40-1 establishes access permission/denial (association). At this time, authentication in response to the access request is performed between radio mobile terminal 60-1 and authentication server 20, and an authentication status and an association ID are sent as authentication result information from authentication server 20 to radio base station 40-1. Upon reception of the authentication result information, radio base station 40-1 sends the association information and the authentication result information of radio mobile terminal 60-1 to layer 2 terminal device 50-1, which registers the supplied information in authentication management table 54a.

Subsequently, layer 2 switch device 50-1 manages the association information and the authentication result information of radio mobile terminal 60-1 in its own authentication management table 54a. The crypt key information that is used for encryption in the radio communications zone between radio mobile terminal 60 and radio base station 40 is also sent to layer 2 switch device 50-1, which registers the crypt key information in authentication management table 54a for management.

Then, a process in which radio mobile terminal 60-1 moves from the service area of radio base station 40-1 into the service area of radio base station 40-2 and switches its radio communication companion through which radio mobile terminal 60-1 takes part in the network for communications, from radio base station 40-1 to radio base station 40-2 will be described below with reference to FIG. 5.

At the time of hand-off between the radio base stations, radio mobile terminals 40-1, 40-2 are connected to layer 2 switch device 50-1, and the association information, authentication result information, and crypt key information of radio mobile terminal 60-1 are managed in authentication management table 54a of layer 2 switch device 54.

When radio base station 40-2 receives a re-authentication request from radio mobile terminal 60-1 that has completed the authentication process and taken part in the network through radio base station 40-1, radio base station 40-2 sends an inquiry to layer 2 switch device 50-1 to which it is connected to ask for the association information and authentication result information of radio mobile terminal 60-1. In response to the inquiry from radio base station 40-2, layer 2 switch device 50-1 checks the authentication result information from the radio base station to which radio mobile terminal 60-1 belonged prior to switching, from the association information of radio mobile terminal 60-1 that is stored in authentication management table 54a in its own memory 54. If radio mobile terminal 60-1 has already been authenticated, then layer 2 switch device 50-1 sends a response indicative of an access permission to radio base station 40-2. Based on the response from layer 2 switch device 50-1, radio base station 40-2 sends an authentication result in response to the re-authentication request from radio mobile terminal 60-1.

If the radio communications zone between radio mobile terminal 60 and radio base station 40 is encrypted, then layer 2 switch device 50-1 sends the crypt key information stored in the authentication management table 54a in its own memory 54 to radio base station 40-2. Radio mobile terminal 60 can therefore use the same crypt key continuously, thereby shortening the period of time required for switching.

With the network system according to the present embodiment, when radio mobile terminal 60-1 switches between radio base stations 60 to which it belongs, layer 2 switch device 50-1 manages the association information, authentication result information, and crypt key information of radio mobile terminal 60-1, and responds to an inquiry from the radio base station 40 based on a re-authentication request upon switching between radio base stations 40 as radio mobile terminal 60-1 moves. Consequently, ratio mobile terminal 60-1 is not required to be re-authenticated by authentication server 20, and hence the period of time required for switching is further shortened.

If the network system according to the present embodiment has a plurality of layer 2 switch devices 50 as shown in FIG. 1, then the association information, authentication result information, and crypt key information of radio mobile terminals 60 are shared between layer 2 switch devices 50. Therefore, the period of time required for switching between radio base stations 40 connected to differing layer 2 switch devices 50 and re-authenticating radio mobile terminal 60 is shortened. When layer 2 switch device 50 receives an authentication request, layer 2 switch device 50 refers to authentication management table 54a in its own memory 54. If authentication management table 54a does not store the authentication result information of ratio mobile terminal 60 from which the authentication request is sent, layer 2 switch device 50 identifies another layer 2 switch device 50 which stores the authentication result information of ratio mobile terminal 60 based on the BSSID of the association information, and sends an inquiry to identified layer 2 switch device 50 and acquires the authentication result information of ratio mobile terminal 60 from which the authentication request is sent. Then, layer 2 switch device 50 sends the authentication result information to radio base station 40 to enable radio base station 40 to re-authenticate radio mobile terminal 60. In this manner, the period of time required for switching is shortened.

As described above, layer 2 switch devices 50 provides a re-authentication function by holding and sharing the result of an authentication process which authentication server 20 has performed on the radio mobile terminal 60 through radio base station 40. Consequently, a re-authentication process at the time radio mobile terminal 60 switches between radio base stations 40 to which it belongs is dispensed with, thereby shortening the period of time required to re-authenticate radio mobile terminal 60.

Stated otherwise, according to the present embodiment, when radio mobile terminal 60 moves and switches between radio base stations 40 to which it belongs, since layer 2 switch devices 50 store the association information, authentication result information, and crypt key information of radio mobile terminals 60 in its internal memory 54, authentication server 20 is not required to re-authenticate radio mobile terminal 60. Therefore, the period of time required for switching is shortened.

Radio mobile terminals 60 may be any devices insofar as they are terminals capable of establishing communications with terminal devices upon authentication and of performing radio data communications with radio base stations 40. For example, radio mobile terminals 60 may be notebook PCs (Personal Computers), PDAs (Personal Digital Assistants), cellular phones, etc.

Multimedia terminal device 30 has been described as a terminal device with which radio mobile terminals 60 communicate through LAN 10. However, any devices that can be connected to LAN 10 and communicate with radio mobile terminals 60, e.g., PC, PDAs, etc., may be used in place of multimedia terminal device 30.

The network that has been described as LAN 10 in the above embodiment is not limited to LANs, but may be any networks that can communicate with computers. For example, any of various networks such the Internet, intranets, WANs (Wide Area Networks), etc. may be used in place of LAN 10.

While a preferred embodiment of the present invention has been described using specific terms, such description is for illustrative purposes only, and it is to be understood that changes and variations may be made without departing from the spirit or scope of the following claims.

1. A layer 2 switch device incorporated in a network system and connected to a plurality of radio base stations, and also connected by a network to a terminal device and an authentication server for authenticating communications between the radio base stations, radio mobile terminals which performs radio communications with the radio base stations, and the terminal device, said layer 2 switch device comprising:
a base station communication unit and a network communication unit;
memory means storing an authentication management table;
storing means for storing authentication result information sent from said authentication server, which is connected through said network communication unit, to a radio base station when a radio mobile terminal belonging to said radio base station, which is connected through said base station communication unit, is authenticated by said authentication server, in association with information specifying said radio mobile terminal into said authentication management table; and
authenticating means for authenticating the radio mobile terminal based on said authentication result information stored in said authentication management table when an authentication request is sent from the radio mobile terminal.

2. A layer 2 switch device according to claim 1, wherein said storing means stores association information of the radio mobile terminal at the time the radio mobile terminal is authenticated by said authentication server, in association with the information specifying said radio mobile terminal into said authentication management table.

3. A layer 2 switch device according to claim 1, wherein said storing means stores crypt key information used to encrypt radio communications between said radio mobile terminal and said radio base station, in association with the information specifying said radio mobile terminal into said authentication management table.

4. A layer 2 switch device according to claim 1, further comprising:
control means for, if said authentication result information is stored in association with the information specifying said radio mobile terminal in said authentication management table when the authentication request is sent from the radio mobile terminal through the radio base station, sending the stored authentication result information to the radio base station, for, if another layer 2 switch device is connected to said network and stores said authentication result information in an authentication management table thereof, sending an inquiry to said other layer 2 switch device to ask for said authentication result information, and for, if said authentication result information is not stored in any layer 2 switch devices connected to said network, sending said authentication request to said authentication server.

5. A layer 2 switch device according to claim 4, wherein when the authentication request is sent from the radio mobile terminal through the radio base station and the information stored in said authentication management table is sent to said radio base station in response to said authentication request, the information which is stored in said authentication management and sent to said radio base station includes crypt key information used to encrypt radio communications between said radio mobile terminal and said radio base station.

6. A radio base station incorporated in a network system and connected to a layer 2 switch device which is connected by a network to a terminal device and an authentication server for authenticating communications between the radio base stations, radio mobile terminals which performs radio communications with the radio base stations, and the terminal device, said radio base station comprising:
a radio communication unit and a wired communication unit; and
control means, responsive to an authentication request sent from a radio mobile terminal to said radio communication unit, for sending an inquiry to the layer 2 switch device through said wired communication unit and performing an authentication process based on a response to said inquiry.
